(19) United States
(12) Patent Application Publication
(10) Pub. No.: US 2025/0372760 A1
(43) Pub. Date: Dec. 4, 2025

(54) HEAT-EXCHANGE PLATE FOR BATTERY PACK WITH STRUCTURAL PLATE

(71) Applicant: VALEO SYSTEMES THERMIQUES, La Verriere (FR)

(72) Inventors: Lionel ROBILLON, La Verriere (FR); Christian CASENAVE, La Verriere (FR); Fabienne TOURNEUX, La Verriere (FR)

(73) Assignee: VALEO SYSTEMES THERMIQUES, La Verriere (FR)

(21) Appl. No.: 18/875,775

(22) PCT Filed: Jun. 23, 2023
(86) PCT No.: PCT/EP2023/067088

§ 371 Date: Dec. 17, 2024

(30) Foreign Application Priority Data
Jun. 24, 2022 (FR) FR2206320

(51) Int. Cl. H01M 10/6556; B21D 53/04; H01M 10/613; H01M 10/625; H01M 10/6554; H01M 10/6568

(52) U.S. Cl. CPC H01M 10/6556; B21D 53/04; H01M 10/613; H01M 10/625; H01M 10/6554; H01M 10/6568; H01M 2220/20

(57) ABSTRACT

The invention relates to a heat exchange plate for thermal management of a battery pack, having first and second plates, at least the first plate having at least one channel, the first and second plates adjoining one another such that the channel partially delimits at least one duct of a circuit for circulation of a heat-transfer fluid. The first plate is made of a first material and the second plate is made of a second material that is different from the first material and confers a structural function on the second plate.

### TECHNICAL FIELD

The present invention relates to the thermal regulation of batteries and more particularly to heat exchange plates for the thermal management of battery packs, in particular in the automotive field.

### BACKGROUND OF THE INVENTION

The thermal regulation of batteries and battery packs, in particular in the automotive field and even more particularly that of electric and hybrid vehicles, is an important point since if the batteries are subjected to excessively cold temperatures, their autonomy may drop sharply and if they are subjected to excessively high temperatures, there is a risk of thermal runaway that may go so far as to destroy the battery.

In order to regulate the temperature of the batteries, it is known to add a device for regulating the temperature of the battery module. These devices generally use heat-transfer fluids circulating, for example by means of a pump, in a duct circuit, said duct circuit passing in particular beneath or inside a heat exchange plate in direct contact with the batteries.

Heat-transfer fluids can thus absorb heat emitted by the one or more batteries in order to cool them and evacuate this heat at one or more heat exchangers, such as for example a radiator or a refrigerant. Heat-transfer fluids can also, if need be, supply heat so as to heat said batteries, for example if they are connected to an electrical resistor or to a positive temperature coefficient (PTC) heater.

The heat-transfer fluids that are generally used are ambient air or liquids such as for example water. Since liquids are better conductors of heat than gases, this is a solution that is favored since it is more effective.

Generally, the heat exchange plates in direct contact with the cells are placed beneath the batteries, said batteries thus resting on said heat exchange plates. The heat exchange plates are generally made of metal and are made up of two metallic plates that are pressed and brazed against one another so as to form one or more circuits of ducts for circulation of the heat-transfer fluid between a fluid inlet and outlet.

In order to allow mechanical strength of the battery packs, the latter, provided with the battery cooler exchanger, have to be connected to a structural element and have to be protected from external elements. This function, referred to as “structural”, is currently ensured by an assembly of beams, crossmembers and protectors (structural panel positioned beneath the heat exchange plates). Such a structural assembly allows resistance to crash tests and to impacts, but also to loadings of the battery modules on the battery cooler. The elements constituting the structural function are manufactured in a known manner with materials that offer mechanical properties, such as the elastic limit (Rp0.2) and the breaking strength (Rm), that are very superior.

However, the manufacture of a structural panel support, and the elements necessary for fastening the battery pack to the beams, represent an additional cost for the motor vehicle manufacturer, and the use thereof increases the weight of the vehicle, and consequently increases the CO2 emissions.

### SUMMARY OF THE INVENTION

One of the aims of the invention is to propose a heat exchange plate that at least partially remedies the drawbacks of the prior art and to propose a structural heat exchange plate, while at the same time respecting the objectives of recyclability and the search for carbon neutrality.

The present invention therefore relates to a heat exchange plate for thermal management of a battery pack, having first and second plates, at least the first plate having at least one channel (the first plate comprises a relief forming at least one channel when combined with the second plate), the first and second plates adjoining one another such that said channel partially delimits at least one duct of a circuit for circulation of a heat-transfer fluid, and wherein the first plate is made of a first material and the second plate is made of a second material that is different from the first material and confers a structural function on the second plate.

Such a structural heat exchange plate makes it possible to reduce the number of crossmembers and of elements (casing, points of attachment, reinforcement, beams, etc.) necessary for assembling the battery modules and for the mechanical strength of the battery packs.

Thus, the structural heat exchange plate according to the invention makes it possible to achieve a cost saving, a mass saving and a reduction in CO2 emissions for motor vehicle manufacturers.

According to further optional features of the thermal plate, taken individually or in combination:
the first material has a lower elastic limit than the second material, making it possible to avoid the brazing step bringing about deformations of the thermal plate, and therefore making it possible to respect the intended dimensions of the thermal plate.
the second material has an elastic limit (Rp0.2) greater than 190 MPa, preferably greater than 200 MPa.
the second material has a breaking strength (Rm) greater than 220 MPa, preferably greater than 240 MPa
the second material has an elongation (A %) at break greater than 22%.
the first and second materials are metallic materials.
the first and second materials are aluminum alloys allowing the first plate and the second plate to be assembled via a Nocolok® brazing process.
the second material predominantly comprises an aluminum alloy of the 6000 series, preferably at least 95%.
the first material predominantly comprises an aluminum alloy of the 3000 series, preferably at least 95%.
at least one of the faces of at least one of the plates has an anti-corrosion layer.
the anti-corrosion layer is made of aluminum alloy of the 1000, 3000+Zn or 7000 series.
when the anti-corrosion layer is made of aluminum alloy of the 3000+Zn series, the Zn concentration is between 0.5% and 1.8%.
at least one of the faces of the second plate has a magnesium barrier layer.
the barrier layer is made of aluminum alloy of the 1000, 3000+Zn or 7000 series.
at least one of the faces of the second plate has a magnesium barrier layer, preferably made of aluminum alloy of the 1000, 3000+Zn or 7000 series.
when the barrier layer is made of aluminum alloy of the 3000+Zn series, the Zn concentration is between 0.5% and 1.8%.
at least one of the internal faces of at least one of the plates has a brazing layer.
the brazing layer is made of aluminum alloy of the 4000 series, preferably 4343 or 4045.
the second plate (30) has, on each of its faces, a layer made of aluminum alloy of the 7000 series, preferably 7072, or the 3000+Zn series, preferably 3003+Zn.
when each of the faces of the second plate (30) has a layer made of aluminum alloy of the 3000+Zn series, the Zn concentration is between 0.5% and 1.8%.

The invention also relates to a method for manufacturing a heat exchange plate as described above, involving the following steps:
i—producing the first plate by means of the first material, and producing the second plate by means of the second material;
ii—forming at least one channel on at least one of the first and second plates, preferably by pressing;
iii—assembling the two plates in a sealed manner; and
iv—applying at least one treatment for artificial aging of the assembled assembly, in order to improve the structural performance, for example by means of a heat treatment.

According to further optional features of the method, taken individually or in combination:
step ii) is carried out by means of a stamping process.
step iii) is carried out by means of a brazing process, preferably Nocolok® brazing.
step iv) involves heat treatment of the thermal plate.
the heat treatment involves a step of heating the thermal plate at 225° C. for 45 min.
a second material is used that predominantly comprises an aluminum alloy of the 6000 series.
step i) involves a step of covering at least one of the faces of at least one of the plates with at least one functional layer, of the anti-corrosion, magnesium barrier, and/or brazing type.

### BRIEF DESCRIPTION OF THE DRAWINGS

Further features and advantages of the invention will become more clearly apparent upon reading the following description, which is given by way of illustrative and non-limiting example, and the appended drawings, in which:

FIG. 1 shows a schematic perspective depiction of a heat exchange plate according to the invention,

FIG. 2 is a detail of FIG. 1, illustrating a part of a channel of the heat exchange plate,

FIG. 3 shows a schematic exploded perspective depiction of a heat exchange plate according to one embodiment,

FIGS. 4A, 4B, 4C illustrate exemplary superpositions of anti-corrosion and brazing layers around the core of the first plate,

FIGS. 5A, 5B, 5C illustrate exemplary superpositions of anti-corrosion and barrier layers around the core of the second plate, and

FIG. 6 is a diagram illustrating the various steps of an exemplary method for manufacturing a thermal plate according to the invention.

In the various figures, identical elements bear the same reference signs.

### DETAILED DESCRIPTION OF THE INVENTION

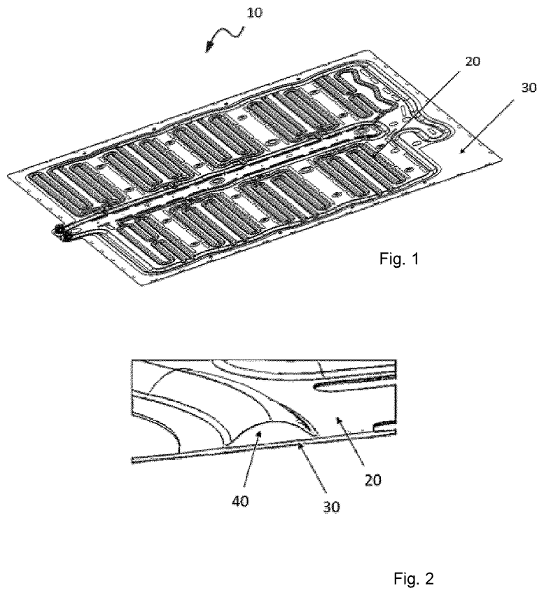

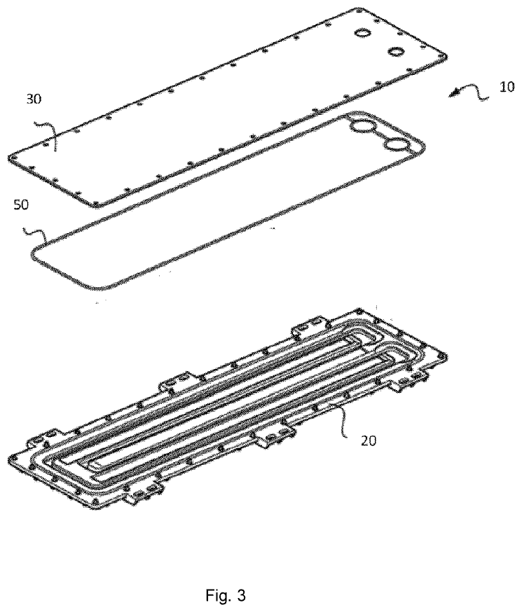

As illustrated in FIGS. 1 and 2, the heat exchange plate 10 for the thermal management of a battery pack 200 has a first plate 20 (“channel plate”) and a second plate 30 (“base plate”). FIG. 3 shows a schematic exploded perspective depiction of a heat exchange plate according to one embodiment.

At least one of the first 20 and second 30 plates has channels 40. In the example in FIG. 1, it is the first plate 20, which is then intended to come into contact with the battery pack 200.

According to one exemplary embodiment, the plates 20 and 30 of the thermal plate 10 have a substantially rectangular shape, with a length of 1700 mm and a width of 1300 mm. Each plate has a thickness of between 0.5 mm and 2 mm.

The first 20 and second 30 plates adjoin one another such that the channels 40 delimit a duct of a circuit for circulation of a heat-transfer fluid. Preferably, the duct is U-shaped and extends between a heat-transfer fluid inlet and outlet that are formed respectively by connecting pipes.

The heat exchange plate 10 may also have holding elements (not shown) allowing said exchange plate to be fastened to the battery pack or to the battery. The heat exchange plate 10 may also have a seal 50 placed between the first 20 and the second plate 30 in order to ensure sealing between the latter.

A battery pack 200 is understood to mean a set of cells that are electrically connected to each other and form said battery pack 200, or else a single battery of large size.

According to the invention, the first plate 20 is made of a first material, and the second plate 30 is made of a second material that is different from the first material and confers a structural function on the second plate 30.

In order to obtain this structural function, a second material is used that has an elastic limit (Rp0.2) greater than 190 MPa, preferably greater than 200 MPa.

This elastic limit (Rp0.2) is measured according to the standardized ISO:6892-1 method.

Preferably, the second material also has a breaking strength (Rm) greater than 220 MPa, preferably greater than 240 MPa.

This breaking strength (Rm) is measured according to the standardized ISO:6892-1 method.

Preferably, the second material also has an elongation (A %) at break greater than 22%.

This elongation at break (Rm) is measured according to the standardized ISO:6892-1 method.

As regards the first material, it is chosen from materials having a lower elastic limit than the second material. The value of the elastic limit is chosen so as to relieve at least some of the stresses caused by the second plate 30 that has a structural function.

Preferentially, use is made of materials that are compatible with the current process for forming plates, pressing, and with the current process for manufacturing the heat exchange plates: brazing. Thus, the first and second materials are chosen from metals. Preferably, the first and second materials are chosen so as to allow the two plates 20 and 30 to be assembled via a Nocolok® brazing process.

According to one preferred embodiment, the second material predominantly comprises, preferably at least 95% (for recycling reasons in particular), an aluminum alloy of the 6000 series, the alloying elements of which are magnesium and silicon. Specifically, this alloy offers superior mechanical properties to an aluminum alloy of the 3000 series, which is conventionally used to manufacture the two plates of a heat exchange plate.

By virtue of its superior mechanical properties, and in particular its stiffness, the type 6000 aluminum confers a structural function on the thermal plate 1. However, since the aluminum alloy of the 6000 series does not deform during the mechanical strength tests, the use of this material for the second plate 30 can lead, depending on the design of the thermal plate 1, to a significant increase in the local forces, and thus cause non-conformities, or even breaks, in the mechanical strength tests (pressure cycle, vibration, bursting strength, etc.). This is because it is known, in particular during fatigue tests, that the stress values of a “harder” material with a low level of elongation (A %) at break will locally increase, since it deforms less easily and allows less “pulmonation” of the part, and is therefore less resistant to the fatigue tests.

As a result, according to this preferred embodiment, the first material of the first plate 20 is an aluminum alloy of the 3000 series, making it possible to relieve at least some of the stresses caused by the second plate 30 that has a structural function.

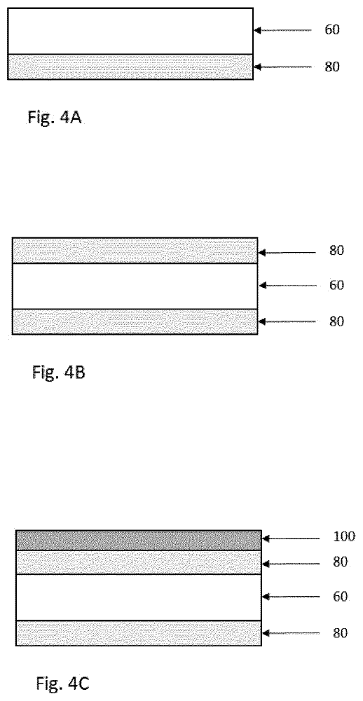

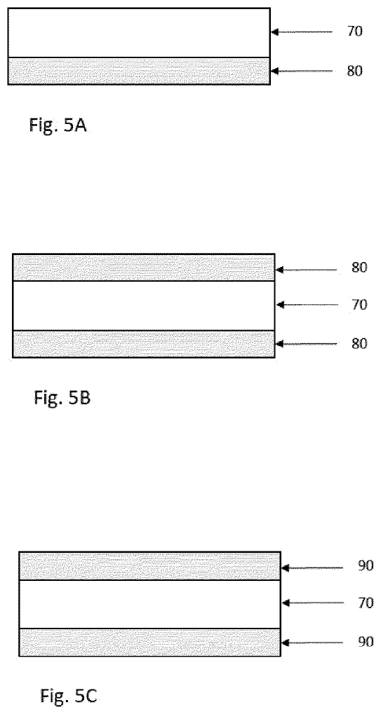

According to certain embodiments, additional layers are applied to the plates 20 and 30. These embodiments are illustrated in FIGS. 4A, 4B, 4C and 5A, 5B, 5C, and described below.

### Anti-Corrosion Layers 80

According to one embodiment, illustrated in FIGS. 4A, 4B, 4C and 5A, 5B, 5C, each plate 20, 30 is covered on at least one of the two faces, preferably on both faces, with an anti-corrosion layer 80, making it possible to protect the core of the plate 60, 70, which is made of first and second materials.

FIG. 4A illustrates the superposition of the layers forming the first plate 20, when the core 60 made of first material is covered with a single anti-corrosion layer 80.

FIG. 4B illustrates the superposition of the layers forming the first plate 20, when the core 60 made of first material is covered with an anti-corrosion layer 80 on both of its faces.

FIG. 5A illustrates the superposition of the layers forming the second plate 30, when the core 70 made of second material is covered with a single anti-corrosion layer 80.

FIG. 5B illustrates the superposition of the layers forming the second plate 30, when the core 70 made of second material is covered with an anti-corrosion layer 80 on both of its faces.

According to one exemplary embodiment, the anti-corrosion layer 80 is made of aluminum alloy of the 1000, 3000+Zn or 7000 series. This layer behaves as a sacrificial layer for combating internal and/or external corrosion. The advantage of the layer of the 3000+Zn series is that it maintains the mechanical properties provided by the core alloy.

The thickness of the anti-corrosion layer 80 is between 2.5% and 10% of the plate thickness.

### Layer 90 Forming a Magnesium Diffusion Barrier (Second Plate)

When the second material is rich in magnesium, it is important, so as to maintain the structural properties of this material, that the magnesium remains in the core 70 made of second material. However, during the brazing step, which is necessary for assembling the two plates 20 and 30, the magnesium has a tendency to escape and migrate out of the core 70 made of second material.

Thus, according to one embodiment, illustrated in FIG. 5C, the second plate 30 is covered on at least one of its two faces, preferably on both faces, with a barrier layer 90, acting as a magnesium diffusion barrier during the brazing process. The magnesium thus remains in the core of the second layer, which is made of second material, and thus preserves its structural properties.

According to one exemplary embodiment, the barrier layer 90 is made, like the anti-corrosion layer 80, of aluminum alloy of the 1000, 3000+Zn or 7000 series.

The thickness of the barrier layer 90 is between 2.5% and 10% of the plate thickness.

### Brazing Layers 100 (First Plate)

According to one embodiment, illustrated in FIG. 4C, at least one of the first and second plates 20, 30 is covered on one of its faces, the face positioned facing the other plate, with a brazing layer 100, making it possible to optimize the brazing process.

According to one exemplary embodiment, the brazing layer 100 is made of aluminum alloy of the 4000 series, preferably 4343 or 4045.

The thickness of the brazing layer 100 is between 2.5% and 10% of the plate thickness.

FIG. 4C illustrates the superposition of the layers forming the first plate 20 when the core 60 made of first material is covered with an anti-corrosion layer 80 on both of its faces, and with a brazing layer 100.

### EXEMPLARY EMBODIMENTS

### Example 1

The anti-corrosion layer 80 is an aluminum alloy of the 7000 series, preferably 7072. The anti-corrosion layer 80 is applied to the external face of the first plate 20 (not facing the plate 30), and to the external face of the second plate 30 (not facing the plate 20).

The internal face of the plate 20 is covered with a brazing layer made of aluminum alloy of the 4000 series, preferably 4343 or 4045.

The core of the first plate is made of aluminum alloy of the 3000 series.

The core of the second plate is made of aluminum alloy of the 6000 series.

### Example 2

The first plate 20 is in accordance with that of example 1, but the second plate 30 is covered on both of these faces with a layer that is both a barrier layer and an anti-corrosion layer, made of aluminum alloy of the 1000, 3000+Zn or 7000 series.

### Example 3

The second plate 30 has a core made of 6060 aluminum alloy covered with barrier layers made of 1050 aluminum alloy.

### Example 4

In certain embodiments, the second plate 30 has a core made of aluminum alloy of the 6000 series, covered with a layer of 7072 aluminum alloy acting as barrier and anti-corrosion layer.

Advantageously, the layer of 7072 aluminum alloy acts as a barrier layer, in order to form a barrier to the migration of the magnesium during the brazing process.

Advantageously, the layer of 7072 aluminum alloy acts as a sacrificial layer so as to meet the corrosion requirements.

Finally, advantageously, the combination of an aluminum alloy of the 6000 series and a 7072 aluminum alloy is preferred since, inter alia, it is favorable in terms of recyclability.

The use of a 3000+Zn layer may favor anti-corrosion protection and maintenance of the mechanical properties, in particular for reduced thicknesses.

### MANUFACTURING METHOD

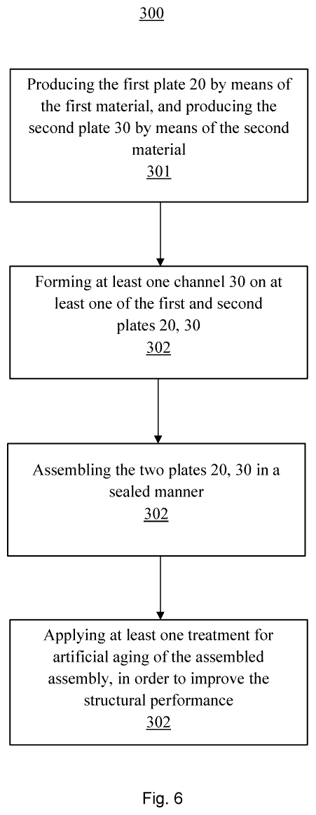

The invention also relates to a method 300 for manufacturing a heat exchange plate 1 for thermal management of a battery pack 200 according to the invention. As illustrated in FIG. 6, the method involves the following steps:
i—producing 301 the first plate 20 by means of the first material, and producing the second plate 30 by means of the second material;
ii—forming 302 at least one channel 30 on at least one of the first 20 and second 30 plates, for example by means of a stamping process;
iii—assembling 303 the two plates in a sealed manner, for example by means of a brazing process, preferably Nocolok® brazing;
iv—applying 304 at least one treatment for artificial aging of the assembled assembly, in order to improve the structural performance, for example by means of a heat treatment.

According to one example, the heat treatment (step iv) consists in heating the thermal plate 1 at 225° C. for 45 min.

According to one preferred embodiment, a second material is used that predominantly comprises an aluminum alloy of the 6000 series, preferably at least 95%. Specifically, such an alloy is curable by aging, and therefore curable by the brazing process (step iv) used to assemble the two plates 20 and 30. The brazing acts as a solution heat treatment. In addition, the mechanical strength of the second plate 30 is improved and superior by virtue of the artificial aging treatment (step v).

Advantageously, the method involves, in step i), covering the plates 20 and/or 30 with functional layers:
covering at least one of the faces of at least one of the plates 20 and 30 with an anti-corrosion layer 80; and/or
covering at least one of the faces of the second plate 30 with a magnesium barrier layer 90; and/or
covering the internal face (face facing the other plate) of at least one of the plates 20 and 30 with a brazing layer 100.

With such a treatment applied to the thermal plate 1 of example 3 (the second plate 30 has a core 70 made of 6060 aluminum alloy covered with barrier layers made of 1050 aluminum alloy), the following mechanical properties are obtained for a plate 30 with a thickness of 2 mm:
Rp0.2: 196 MPa
Rm: 227 MPa
A50%: 9.8

### LIST OF REFERENCES

10 heat exchange plate for the thermal management of a battery pack
20: first plate (“channel plate”) of the heat exchange plate 10
30: second plate (“base plate”) of the heat exchange plate 10
40: channel of the heat exchange plate 10
50: seal of the heat exchange plate 10
60: core made of first material of the first plate 20
70: core made of second material of the second plate 30
80: anti-corrosion layer
90: magnesium diffusion barrier layer
100: brazing layer
200: battery pack

What is claimed is:

1. A heat exchange plate for thermal management of a battery pack, comprising first and second plates, at least the first plate having at least one channel, the first and second plates adjoining one another such that said channel partially delimits at least one duct of a circuit for circulation of a heat-transfer fluid, wherein said first plate is made of a first material and said second plate is made of a second material that is different from the first material and confers a structural function on said second plate.

2. The heat exchange plate as claimed in claim 1, wherein the first material has a lower elastic limit than the second material.

3. The heat exchange plate as claimed in claim 1, wherein said second material has an elastic limit greater than 190 MPa.

4. The heat exchange plate as claimed in claim 1, wherein said second material has a breaking strength greater than 220 MPa.

5. The heat exchange plate as claimed in claim 1, wherein said second material has an elongation at break greater than 22%.

6. The heat exchange plate as claimed in claim 1, wherein the first and second materials are aluminum alloys allowing the first plate and the second plate to be assembled via a Nocolok® brazing process.

7. The heat exchange plate as claimed in one claim 1, wherein said second material predominantly includes an aluminum alloy of the 6000 series.

8. The heat exchange plate as claimed in claim 1, wherein said first material predominantly includes an aluminum alloy of the 3000 series.

9. The heat exchange plate as claimed in claim 1, wherein at least one of the faces of at least one of the plates has an anti-corrosion layer.

10. The heat exchange plate as claimed in claim 1, wherein at least one of the faces of the second plate has a magnesium barrier layer.

11. The heat exchange plate as claimed in claim 1, wherein at least one of the internal faces of at least one of the plates has a brazing layer.

12. The heat exchange plate as claimed in claim 1, wherein the second plate has, on each of its faces, a layer made of aluminum alloy of the 7000 series.

13. A method for manufacturing a heat exchange plate including first and second plates, at least the first plate having at least one channel, the first and second plates adjoining one another such that said channel partially delimits at least one duct of a circuit for circulation of a heat-transfer fluid, wherein said first plate is made of a first material and said second plate is made of a second material that is different from the first material and confers a structural function on said second plate, the method comprising:
i—producing the first plate by means of the first material, and producing the second plate by means of the second material;
ii—forming at least one channel on at least one of the first and second plates;
iii—assembling the two plates in a sealed manner; and
iv—applying at least one treatment for artificial aging of the assembled assembly, in order to improve the structural performance.

14. The method as claimed in claim 13, wherein producing the first plate by means of the first material, and producing the second plate by means of the second material involves covering at least one of the faces of at least one of the plates with at least one functional layer, of the anti-corrosion, magnesium barrier and/or brazing type.
